(19) United States
(12) Patent Application Publication
(10) Pub. No.: US 2022/0115699 A1
(43) Pub. Date: Apr. 14, 2022

(54) ELECTROCHEMICAL DEVICE

(71) Applicant: Panasonic Intellectual Property Management Co., Ltd., Osaka (JP)

(72) Inventors: HIDEO SAKATA, Osaka (JP); NAO MATSUMURA, Osaka (JP); HIDEKI SHIMAMOTO, Kyoto (JP); TOSHIAKI SHIMIZU, Kyoto (JP)

(21) Appl. No.: 17/422,423

(22) PCT Filed: Jan. 22, 2020
(86) PCT No.: PCT/JP2020/002168

§ 371 Date: Jul. 12, 2021

(30) Foreign Application Priority Data
Jan. 30, 2019 (JP) 2019-014782

(51) Int. Cl. H01M 10/0567; H01M 10/0569; H01M 10/0525; H01M 10/0568; H01M 4/60

(52) U.S. Cl. CPC H01M 10/0567; H01M 10/0569; H01M 2004/028; H01M 10/0568; H01M 4/602; H01M 10/0525

(57) ABSTRACT

An electrochemical device includes a positive electrode including a positive electrode active material, a negative electrode including a negative electrode active material, and an electrolytic solution. The positive electrode active material includes a conductive polymer, and the electrolytic solution contains anions and cations. The conductive polymer is capable of doping and dedoping of the anions. The cations includes a lithium ion and a quaternary ammonium ion.

### TECHNICAL FIELD

The present invention relates to an electrochemical device that includes an active layer containing a conductive polymer.

### BACKGROUND

In recent years, an electrochemical device having a property intermediate between a lithium ion secondary battery and an electric double layer capacitor attracts attention. And for example, use of a conductive polymer as a positive electrode material is considered (for example, PTL 1). The electrochemical device containing the conductive polymer as the positive electrode material is charged and discharged by adsorption (doping) and desorption (dedoping) of anions. Thus, the electrochemical device has higher output than output of a general lithium ion secondary battery because of the small reaction resistance.

### CITATION LIST

### Patent Literature

PTL 1: Unexamined Japanese Patent Publication No. 2014-35836

### SUMMARY

In the electrochemical device described above, unlike the lithium ion secondary battery, a part of anions in an electrolytic solution moves to a positive electrode and lithium ions in the electrolytic solution move to a negative electrode in accordance with charging. Thus, a concentration of a lithium salt in the electrolytic solution is decreased. This phenomenon makes ion conductivity of the electrolytic solution decrease, and thus an internal resistance of the electrochemical device is likely to increase.

In order to suppress the increase of the internal resistance, it is considered that the content of the lithium salt added to the electrolytic solution in advance is increased. The increase of the content of the lithium salt, however, makes viscosity of the electrolytic solution increase. As a result, since the ion conductivity is decreased, it is difficult to decrease the internal resistance.

In view of the above problems, an electrochemical device according to one aspect of the present invention includes a positive electrode including a positive electrode active material, a negative electrode including a negative electrode active material, and an electrolytic solution. The positive electrode active material includes a conductive polymer, and the electrolytic solution contains anions and cations. The conductive polymer is capable of doping and dedoping of the anions. The cations includes a lithium ion and a quaternary ammonium ion.

According to the present invention, the electrochemical device suppresses an increase in an internal resistance.

### BRIEF DESCRIPTION OF DRAWINGS

FIG. 1 is a schematic sectional view illustrating a positive electrode according to one exemplary embodiment of the present invention.

FIG. 2 is a schematic sectional view illustrating an electrochemical device according to the one exemplary embodiment of the present invention.

FIG. 3 is a schematic view illustrating a configuration of an electrode group according to the exemplary embodiment.

### DESCRIPTION OF EMBODIMENT

An electrochemical device according to an exemplary embodiment of the present disclosure includes a positive electrode including a positive electrode active material, a negative electrode including a negative electrode active material, and an electrolytic solution. The positive electrode active material includes a conductive polymer. The electrolytic solution contains anions and cations. The conductive polymer is capable of doping and dedoping of the anions. The cations include a lithium ion and a quaternary ammonium ion.

In the electrochemical device, it is recommended that a concentration of a salt in the electrolytic solution is increased (for example, more than or equal to 2 mol/L) so as to obtain high ion conductivity even in a state where the positive electrode active material is doped with anions at high concentration. Adding only a lithium salt to the electrolytic solution at high concentration, however, leads to a decrease in the ion conductivity of the electrolytic solution due to an increase in viscosity of the electrolytic solution. In order to solve this problem, by replacing a part of the lithium salt with a quaternary ammonium salt, the ion conductivity of the electrolytic solution can be increased while suppressing the increase of the viscosity. By this configuration, an electrochemical device having a low initial internal resistance can be realized.

Here, A represents a content in molar basis (molar concentration) of the lithium ion in an entirety of the electrolytic solution, and B represents a content in molar basis (molar concentration) of the quaternary ammonium ion in an entirety of the electrolytic solution. A ratio A/B may satisfy 0.2≤A/B. Setting the ratio A/B to more than or equal to 0.2 allows capacitance to be easily exhibited. The ratio A/B may be more than or equal to 1.

From a viewpoint of maintaining low viscosity of the electrolytic solution and obtaining high ion conductivity, the ratio A/B may be less than or equal to 9. Accordingly, setting the ratio A/B to range from 0.2 to 9, inclusive, enables attainment of both high capacitance and a low internal resistance. The ratio A/B may be less than or equal to 6. The ratio A/B may range from 1 to 9, inclusive, and may range from 1 and 6, inclusive. Here, the above ranges of the ratio A/B are values measured in full discharge state. As for the evaluation of the ratio A/B, an electrochemical device is discharged at a constant current of 1 A until a voltage between terminals becomes less than or equal to 2.5 V, and then is disassembled to extract an electrolytic solution. And the ratio A/B is obtained by analyzing the extracted electrolytic solution by ion chromatography.

A concentration of the anions in the electrolytic solution may range from 0.5 mol/L to 3 mol/L, inclusive. The range of the concentration of the anions is values measured in full discharge state, and is obtained by a similar method to the measurement of the ratio A/B.

The lithium ion and the quaternary ammonium ion may be added to a solvent of the electrolytic solution in a form of a salt with an anion. That is, the lithium ion may be added to the solvent of the electrolytic solution in a form of a lithium salt, and the quaternary ammonium ion may be added to the solvent of the electrolytic solution in a form of a quaternary ammonium salt. Usually, the concentration of the anions is equal to a total of a concentration of the lithium ion and a concentration of the quaternary ammonium ion in full discharge state. The concentration of the anions means a concentration calculated on the assumption that all the anions are monovalent. That is, when the anions include a polyvalent anion (such as SO₄²⁻), the concentration of the anions is calculated by multiplying a concentration of the polyvalent anion by a weighting factor corresponding to an ion valence of the polyvalent anion. Note that, when a covering film formation agent described later is added, anions of a bidentate ligand-containing complex are not considered in the calculation for the concentration of the anions.

In the positive electrode of the electrochemical device, the conductive polymer is doped with the anions contained in the electrolytic solution during charging, and the conductive polymer is dedoped during discharging, allowing the anions to move into the electrolytic solution. Accordingly, the concentration of the anions in the electrolytic solution can vary by charging and discharging.

From a viewpoint of increasing capacitance, the concentration of the anions is preferably higher. The concentration of the anions may be, for example, more than or equal to 0.5 mol/L, more than or equal to 1 mol/L, or more than or equal to 1.5 mol/L. From a viewpoint of suppressing a decrease of lithium-ion conductivity, the concentration of the anions may be, for example, less than or equal to 3 mol/L or less than or equal to 2.5 mol/L. The upper limits and the lower limits can be combined in any way.

When the electrolytic solution contains the lithium salt, the ion conductivity may have a highest peak in a range of salt concentration from 1.0 mol/L to 1.2 mol/L, inclusive. In order to increase the capacitance of the electrochemical device, however, a concentration of the cations and a concentration of the anions in the electrolytic solution may be set to higher than or equal to the salt concentration at the peak. In the electrochemical device according to the present disclosure, since the electrolytic solution contains the quaternary ammonium salt, the decrease in the ion conductivity is suppressed even in a skirt region higher than the above salt concentration at the peak.

The quaternary ammonium ion may be added into the electrolytic solution by adding the quaternary ammonium salt to a solvent of the electrolytic solution. The quaternary ammonium salt may be a salt with the same anion as the anion used in the lithium salt or may be a salt with an anion different from the anion used in the lithium salt. The anions may include at least one selected from the group consisting of a hexafluorophosphate ion and a tetrafluoroborate ion.

Examples of the quaternary ammonium ion include a tetraethyl ammonium (TEA) ion, a triethylmethyl ammonium (TEMA) ion, a diethyldimethyl ammonium (DEDMA) ion, a trimethylpropyl ammonium (TMPA) ion, and a trimethylethyl ammonium (TMEA) ion.

The quaternary ammonium ion may have a cyclic structure. In the present disclosure, the quaternary ammonium ion also includes, for example, pyrrolidinium ions such as a spirobipyrrolidinium (SBP) ion and a 1-ethyl-1-methylpyrrolidinium (EMP) ion.

The electrolytic solution may contain, as a covering film formation agent, at least one selected from the group consisting of an unsaturated cyclic carbonate ester, a cyclic carboxylic acid anhydride, and a bidentate ligand-containing complex. Such an electrolytic solution forms a stable covering film on a surface of the negative electrode active material in a negative electrode and thus suppresses a side reaction on the negative electrode. Accordingly, an increase in the internal resistance in accordance with repetition of charging and discharging can be suppressed.

Particularly, when the electrolytic solution contains the quaternary ammonium ion, the quaternary ammonium ion is likely to undergo reductive decomposition on the negative electrode. Note that the unsaturated cyclic carbonate ester and the cyclic carboxylic acid anhydride is more likely to undergo reductive decomposition (have a higher oxidation-reduction potential) than the quaternary ammonium ion. Thus, by adding to the electrolytic solution the covering film formation agent that more easily undergoes reductive decomposition than the quaternary ammonium ion, the covering film formation agent undergo reductive decomposition before reductive decomposition of the quaternary ammonium ion. Hence, a dense solid electrolyte interface (SEI) due to reductive decomposition of the covering film formation agent can be formed on the surface of the negative electrode active material. As a result, the reductive decomposition of the quaternary ammonium ion is suppressed, and progress of the side reaction can be suppressed.

In manufacturing of the electrochemical device, a negative electrode is pre-doped with lithium ions. For example, a negative electrode obtained by forming a metallic lithium layer on a surface of a negative electrode active material layer is impregnated with the electrolytic solution to elute lithium ions from the metallic lithium layer into the electrolytic solution. The eluted lithium ions are stored in the negative electrode active material. In this case, the lithium ions quickly move, so that a potential of the negative electrode can be rapidly decreased (to as low as near 0 V). At this time, a solid electrolyte interface formed on the surface of the negative electrode active material is likely to be non-uniform and to be a film that is lack of denseness.

When the covering film formation agent is added to the electrolytic solution, a dense solid electrolyte interface is likely to be formed on a surface of the negative electrode even in the case that the potential of the negative electrode is rapidly decreased by pre-doping. Particularly, the electrolytic solution containing the unsaturated cyclic carbonate ester easily forms a covering film that is highly dense and has high lithium-ion conductance.

Similarly, the cyclic carboxylic acid anhydride can be decomposed at high speed even at a relatively high potential of the negative electrode. Thus, the cyclic carboxylic acid anhydride can undergo high-speed reductive decomposition along with a rapid decrease in the potential of the negative electrode to form a dense covering film. The electrolytic solution containing the cyclic carboxylic acid anhydride easily forms a more uniform and denser covering film on the surface of the negative electrode active material.

The electrolytic solution further containing the cyclic carbonate ester enables a product generated by reductive decomposition of the cyclic carbonate ester to react with a covering film of the cyclic carboxylic acid anhydride and thus reconstruct the covering film into a denser and more uniform covering film.

In the unsaturated cyclic carbonate ester, a number of carbon atoms and a number of oxygen atoms that form a cyclic structure may be, for example, 5 or 6, and is preferably 5. An unsaturated bond is preferably formed between carbon atoms forming the cyclic structure, but is not necessarily limited to this example. Examples of the unsaturated cyclic carbonate ester include vinylene carbonate (VC), vinyl ethylene carbonate (VEC), and divinyl ethylene carbonate.

Among these esters, the cyclic carbonate ester preferably includes vinylene carbonate (VC).

In the cyclic carboxylic acid anhydride, a number of carbon atoms and a number of oxygen atoms that form a cyclic structure may be, for example, 5 or 6, and is preferably 5. One example of the cyclic carboxylic acid anhydride is maleic anhydride (MAH) or succinic anhydride (SAH).

Further, a bidentate ligand-containing complex can be given as a compound that forms a stable covering film on the surface of the negative electrode active material, similarly to the unsaturated cyclic carbonate ester and the cyclic carboxylic acid anhydride. The bidentate ligand-containing complex can be added to a solvent as, for example, a lithium salt.

The bidentate ligand-containing complex includes, for example, anions that are represented by a following chemical formula (1) and have a structure allowing two carboxylate ions (COO⁻) of a dicarboxylic acid to be coordinately bonded to an element M. M represents boron or phosphorus. N (coordination number) is 4 when M represents boron, and N is 6 when M represents phosphorus. R1 represents a halogen group. k is an integer satisfying k≥1 and N−2k≥0. A halogen ion can be coordinated at a coordination position where the carboxylate ions are not coordinated. Meanwhile, the carboxylate ions are preferably coordinated at all the coordination positions. q is 0 or 1. When q is 1, R2 represents an alkylene group having 1 to 5 carbon atoms. When q is 0, two carbonyl groups are directly bonded to each other. As the dicarboxylic acid, oxalic acid (q=0), malonic acid (q=1 and R2═CH₂), and succinic acid (q=1 and R2═CH₂CH₂) are preferable, and oxalic acid is most preferable.

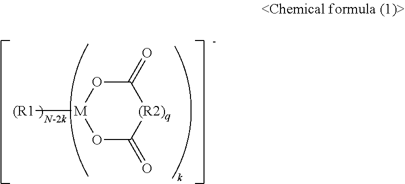

Among the anions represented by the chemical formula (1), more preferable examples include anions represented by following chemical formulae (2) to (6).

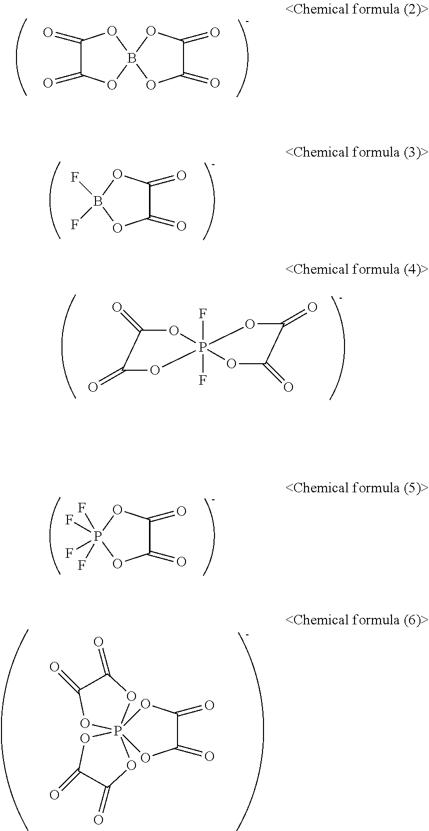

As the covering film formation agent, one of the unsaturated cyclic carbonate ester, the cyclic carboxylic acid anhydride, or the bidentate ligand-containing complex may be added singly to the electrolytic solution, or two or more thereof may be added in combination to the electrolytic solution. When a plurality of types of covering film formation agents are used, at least one type of unsaturated cyclic carbonate ester and at least one type of cyclic carboxylic acid anhydride may be used in combination. The combination can further increase an effect of suppressing the increase of the internal resistance.

A proportion of the covering film formation agent in an entirety of the electrolytic solution ranges, for example, from 0.1% by mass to 10% by mass, inclusive. By setting the proportion of the covering film formation agent in an entirety of the electrolytic solution to more than or equal to 0.1% by mass, a denser and more uniform covering film can be formed and thus the increase of the internal resistance can be easily suppressed. On the other hand, by setting the proportion of the covering film formation agent in an entirety of the electrolytic solution to more than 10% by mass, a film thickness of the covering film is sometimes excessively increased.

The electrolytic solution is obtained by dissolving the lithium salt and the quaternary ammonium salt in a solvent. The solvent may be a nonaqueous solvent.

In the electrochemical device, the conductive polymer is synthesized by electrolytic polymerization or chemical polymerization under a reaction solution containing a raw material monomer. As a solvent of the reaction solution, water is usually used. However, when the reaction solution containing water is used as the solvent, it is difficult to completely remove water even by drying at a high temperature because an amount of water taken in the conductive polymer is large. This sometimes causes that, in the positive electrode, a component contained in the electrolytic solution may be reacted with water in the electrolytic solution or water taken in the conductive polymer to oxidatively decomposed, leading to the increase of the internal resistance.

When the nonaqueous solvent is used to reduce water in the electrolytic solution, in the positive electrode, the oxidation decomposition of the electrolytic solution can be suppressed, and thus the increase of the internal resistance can be suppressed. The nonaqueous solvent may be, for example, γ-butyrolactone (GBL). GBL has a high oxidation resistance and therefore makes it easy to suppress the increase of the internal resistance even when water has been taken in the conductive polymer. Further, GBL has a low melting point and has high ion conductance even at a low temperature, and thus a low internal resistance of the electrochemical device can be maintained even used in a low-temperature environment.

When γ-butyrolactone (GBL) is used as the nonaqueous solvent, it is preferred that the covering film formation agent be added to the electrolytic solution to form a uniform and dense solid electrolyte interface on the surface of the negative electrode active material, because GBL is likely to undergo reductive decomposition in the negative electrode. This measure synergistically suppresses the increase of the internal resistance. This measure can also give an electrochemical device having a low initial resistance (DCR).

A proportion of γ-butyrolactone in an entirety of the electrolytic solution is, for example, more than or equal to 50% by mass, more than or equal to 60% by mass, more than or equal to 70% by mass, more than or equal to 90% by mass, or more than or equal to 95% by mass.

The nonaqueous solvent may contain ethylene carbonate (EC) and/or methyl propionate (MP). Adding EC and/or MP to the nonaqueous solvent of the electrolytic solution can also reduce the initial resistance and improve a float property. Further, ethylene carbonate has a high relative dielectric constant and can therefore increase, on the positive electrode, performance of the electrochemical device also having a property as a capacitor. Further, ethylene carbonate has a high flash point and thus enables the electrochemical device to enhance safety in liquid leakage. On the other hand, adding methyl propionate enables the electrochemical device to suppress a decrease of performance in a low-temperature environment.

### <<Electrochemical Device>>

Hereinafter, a configuration of an electrochemical device according to the present invention is described in more detail with reference to drawings.

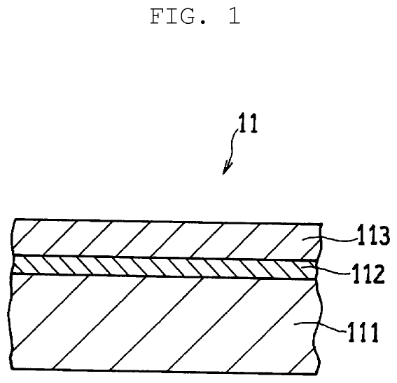

An electrochemical device according the present exemplary embodiment includes an electrode group including a positive electrode, a negative electrode, and a separator disposed between the positive electrode and the negative electrode. The positive electrode includes, as illustrated in FIG. 1, for example, positive current collector 111, carbon layer 112 disposed on positive current collector 111, and active layer 113 disposed on carbon layer 112. Active layer 113 includes a conductive polymer.

Positive current collector 111 is made from, for example, a metallic material, and a natural oxide covering film is easily formed on a surface of the positive current collector. Hence, in order to reduce a resistance between positive current collector 111 and active layer 113, carbon layer 112 containing a conductive carbon material may be formed on positive current collector 111. Carbon layer 112 is formed by, for example, applying a carbon paste containing the conductive carbon material to the surface of positive current collector 111 to form a coating film and thereafter drying the coating film. The carbon paste is, for example, a mixture containing the conductive carbon material, a polymer material, and water or an organic solvent. As the polymer material contained in the carbon paste, generally used is, for example, an electrochemically stable fluorine resin, acrylic resin, polyvinyl chloride, synthetic rubber (e.g., styrene-butadiene rubber (SBR)), liquid glass (sodium silicate polymer), or imide resin.

As the conductive carbon material, it is possible to use graphite, hard carbon, soft carbon, carbon black, and the like. Among these conductive carbon materials, carbon black is preferable in terms of easily forming carbon layer 112 that is thin and has excellent conductivity. An average particle diameter D1 of the conductive carbon material is not particularly limited, but ranges, for example, from 3 nm to 500 nm, inclusive, preferably from 10 nm to 100 nm, inclusive. The average particle diameter is a median diameter (D50) in a volume particle size distribution obtained by a laser diffraction particle size distribution measuring apparatus (the same applies hereinafter). The average particle diameter D1 of carbon black may be calculated by observation with a scanning electron microscope.

The positive electrode includes the positive current collector and conductive polymer layer (active layer) 113 formed on the positive current collector, and conductive polymer layer 113 is in contact with the separator.

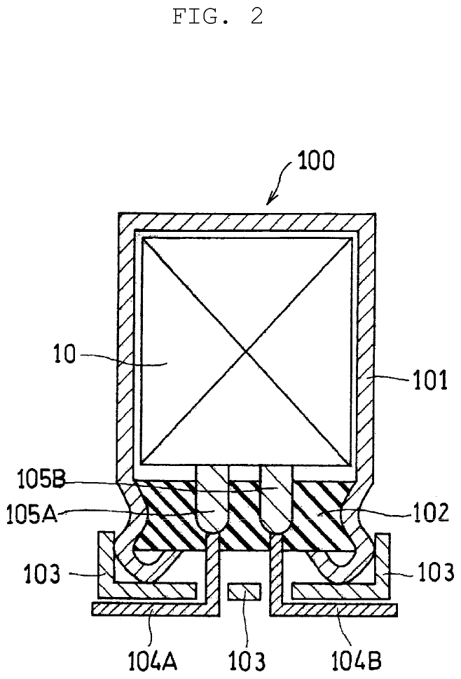

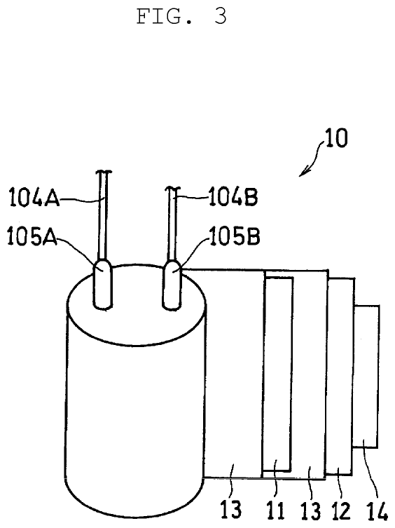

FIG. 2 is a schematic sectional view illustrating electrochemical device 100 according to the present exemplary embodiment, and FIG. 3 is a schematic developed view illustrating a part of electrode group 10 included in same electrochemical device 100.

As illustrated in FIG. 2, electrochemical device 100 includes electrode group 10, container 101 housing electrode group 10, sealing body 102 sealing an opening of container 101, base plate 103 covering sealing body 102, lead wires 104A, 104B lead out from sealing body 102 and penetrating base plate 103, and lead tabs 105A, 105B connecting the lead wires to the electrodes of electrode group 10, respectively. A part of container 101 near an opening end is drawn inward, and the opening end is curled to swage sealing body 102.

### (Positive Current Collector)

As the positive current collector, a sheet-shaped metallic material is used, for example. Used as the sheet-shaped metallic material are, for example, a metal foil, a metal porous body, a punched metal, an expanded metal, and an etched metal. As a material for positive current collector 111, it is possible to use, for example, aluminum, an aluminum alloy, nickel, and titanium, and preferably used are aluminum and an aluminum alloy. A thickness of the positive current collector ranges, for example, from 10 μm to 100 μm, inclusive.

### (Active Layer)

Active layer 113 contains a conductive polymer. In the present exemplary embodiment, the conductive polymer includes a polyaniline. Active layer 113 is formed by, for example, immersing positive current collector 111 in a reaction solution containing a raw material monomer (that is, aniline) of the conductive polymer and electrolytically polymerizing the raw material monomer in presence of positive current collector 111. At this time, the electrolytic polymerization is performed, with positive current collector 111 set as an anode, to form active layer 113 containing the conductive polymer over a surface of carbon layer 112. A thickness of active layer 113 can be easily controlled by appropriately changing, for example, current density in electrolysis or a polymerization time. A thickness of active layer 113 ranges, for example, from 10 μm to 300 μm, inclusive. A weight-average molecular weight of the polyaniline is not particularly limited and ranges, for example, from 1000 to 100000, inclusive.

The polyaniline refers to a polymer containing aniline (C₆H₅—NH₂) as a monomer and having an amine structural unit —C₆H₄—NH—C₆H₄—NH— and/or an imine structural unit —C₆H₄—N═C₆H₄═N—. Meanwhile, the polyaniline usable as the conductive polymer is not limited to these examples. The polyaniline of the present invention includes, for example, a compound containing a benzene ring to a part of which an alkyl group such as a methyl group is attached and a derivative containing a benzene ring to a part of which a halogen group or the like is attached, as long as the compound and the derivative are polymers containing aniline as a basic skeleton.

Active layer 113 may be formed by a method other than the electrolytic polymerization. Active layer 113 containing the conductive polymer may be formed by, for example, chemically polymerizing the raw material monomer. Alternatively, active layer 113 may be formed using a conductive polymer that has been prepared in advance or a dispersion or a solution of the conductive polymer.

Active layer 113 may contain a conductive polymer other than the polyaniline. As the conductive polymer usable together with the polyaniline, a n-conjugated polymer is preferable. As the n-conjugated polymer, it is possible to use, for example, polypyrrole, polythiophene, polyfuran, polythiophene vinylene, polypyridine, and derivatives of these polymers. A weight-average molecular weight of the conductive polymer is not particularly limited and ranges, for example, from 1000 to 100000, inclusive. As a raw material monomer of the conductive polymer usable together with the polyaniline, it is possible to use, for example, pyrrole, thiophene, furan, thiophene vinylene, pyridine, and derivatives of these monomers. The raw material monomer may include an oligomer.

Derivatives of polypyrrole, polythiophene, polyfuran, polythiophene vinylene, and polypyridine mean polymers having, as a basic skeleton, polypyrrole, polythiophene, polyfuran, polythiophene vinylene, and polypyridine, respectively. For example, a polythiophene derivative includes poly(3,4-ethylenedioxythiophene) (PEDOT) and the like.

When active layer 113 contains the conductive polymer other than the polyaniline, the polyaniline preferably has a proportion of more than or equal to 90% by mass in all the conductive polymers constituting active layer 113.

The electrolytic polymerization or the chemical polymerization is preferably performed using a reaction solution containing a dopant. The dispersion liquid or the solution of the conductive polymer also preferably contains a dopant. A π-electron conjugated polymer doped with a dopant exhibits excellent conductance. For example, in the chemical polymerization, positive current collector 111 may be immersed in a reaction solution containing the dopant, an oxidant, and the raw material monomer, and thereafter picked out from the reaction solution and dried. On the other hand, in the electrolytic polymerization, positive current collector 111 and an opposite electrode may be immersed in a reaction solution containing the dopant and the raw material monomer while a current is flowed between the positive current collector and the opposite electrode, with positive current collector 111 set as an anode and the opposite electrode as a cathode.

As a solvent of the reaction solution, water may be used, or a nonaqueous solvent may be used in consideration of solubility of the monomer. As the nonaqueous solvent, preferably used are, for example, alcohols such as ethyl alcohol, methyl alcohol, isopropyl alcohol, ethylene glycol, and propylene glycol. A dispersion medium or solvent of the conductive polymer is also exemplified by water and the nonaqueous solvents described above.

Examples of the dopant include a sulfate ion, a nitrate ion, a phosphate ion, a borate ion, a benzenesulfonate ion, a naphthalenesulfonate ion, a toluenesulfonate ion, a methanesulfonate ion (CF₃SO₃⁻), a perchlorate ion (ClO₄⁻), a tetrafluoroborate ion (BF₄⁻), a hexafluorophosphate ion (PF₆⁻), a fluorosulfate ion (FSO₃⁻), a bis(fluorosulfonyl)imide ion (N(FSO₂)₂⁻), and a bis(trifluoromethanesulfonyl)imide ion (N(CF₃SO₂)₂⁻). A single one or two or more in combination of these ions may be used.

The dopant may be a polymer ion. Examples of the polymer ion include ions of polyvinylsulfonic acid, polystyrenesulfonic acid, polyallylsulfonic acid, polyacrylsulfonic acid, polymethacrylsulfonic acid, poly(2-acrylamido-2-methylpropanesulfonic acid), polyisoprenesulfonic acid, and polyacrylic acid. These dopants may be a homopolymer or a copolymer of two or more monomers. A single one or two or more in combination of these polymer ions may be used.

The reaction solution, or the dispersion liquid of the conductive polymer or the solution of the conductive polymer preferably has a pH ranging from 0 to 4 in terms of easily forming active layer 113.

### (Negative Electrode)

The negative electrode includes, for example, a negative current collector and a negative electrode material layer.

As the negative current collector, a sheet-shaped metallic material is used, for example. Used as the sheet-shaped metallic material are, for example, a metal foil, a metal porous body, a punched metal, an expanded metal, and an etched metal. As a material for the negative current collector, it is possible to use, for example, copper, a copper alloy, nickel, and stainless steel.

The negative electrode material layer preferably contains, as a negative electrode active material, a material that electrochemically stores and releases lithium ions. Examples of such a material include a carbon material, a metal compound, an alloy, and a ceramic material. As the carbon material, graphite, non-graphitizable carbon (hard carbon), and easily graphitizable carbon (soft carbon) are preferable, and graphite and hard carbon are particularly preferable. Examples of the metal compound include silicon oxide and tin oxide. Examples of the alloy include a silicon alloy and a tin alloy. Examples of the ceramic material include lithium titanate and lithium manganate. A single one or two or more in combination of these materials may be used. Among these materials, a carbon material is preferable in terms of being capable of decreasing a potential of the negative electrode.

The negative electrode material layer preferably contains a conducting agent, a binder, or the like in addition to the negative electrode active material. Examples of the conducting agent include carbon black and a carbon fiber. Examples of the binder include a fluorine resin, an acrylic resin, a rubber material, and a cellulose derivative. Examples of the fluorine resin include polyvinylidene fluoride, polytetrafluoroethylene, and a tetrafluoroethylene-hexafluoropropylene copolymer. Examples of the acrylic resin include polyacrylic acid and an acrylic acid-methacrylic acid copolymer. Examples of the rubber material include styrene-butadiene rubber, and examples of the cellulose derivative include carboxymethyl cellulose.

The negative electrode material layer is formed by, for example, mixing the negative electrode active material, the conducting agent, the binder, and the like with a dispersion medium to prepare a negative electrode mixture paste, and applying the negative electrode mixture paste to the negative current collector and then drying the negative electrode mixture paste.

The negative electrode is preferably pre-doped with lithium ions in advance. This process decreases the potential of the negative electrode and thus increases a difference in potential (that is, voltage) between the positive electrode and the negative electrode, improving energy density of the electrochemical device.

Pre-doping of the negative electrode with the lithium ions is progressed by, for example, forming a metallic lithium layer that is to serve as a supply source of the lithium ions on a surface of the negative electrode material layer and impregnating the negative electrode including the metallic lithium layer with an electrolytic solution (e.g., a nonaqueous electrolytic solution) having lithium-ion conductance. At this time, the lithium ions are eluted from the metallic lithium layer into the nonaqueous electrolytic solution, and the eluted lithium ions are stored in the negative electrode active material. For example, when graphite or hard carbon is used as the negative electrode active material, the lithium ions are inserted in between layers of the graphite or in fine pores of the hard carbon. An amount of the lithium ions for the pre-doping can be controlled by a mass of the metallic lithium layer.

The step of pre-doping the negative electrode with the lithium ions may be performed before assembling the electrode group, or the pre-doping may be progressed after the electrode group is housed together with the nonaqueous electrolytic solution in a case of the electrochemical device.

### (Separator)

Preferably used as the separator are, for example, a nonwoven fabric made of cellulose fiber, a nonwoven fabric made of glass fiber, and a microporous membrane, a fabric cloth, and a nonwoven fabric that are made of polyolefin. A thickness of the separator ranges, for example, from 10 μm to 300 μm, inclusive, preferably from 10 μm to 40 μm, inclusive.

### (Electrolytic Solution)

The electrolytic solution has lithium-ion conductance and contains a lithium salt and a solvent that dissolves the lithium salt. In this case, anions of the lithium salt can reversibly repeat doping to the positive electrode and dedoping from the positive electrode. Meanwhile, lithium ions derived from the lithium salt are reversibly stored in the negative electrode and released from the negative electrode.

Examples of the lithium salt include LiClO₄, LiBF₄, LiPF₆, LiAlCl₄, LiSbF₆, LiSCN, LiCF₃SO₃, LiFSO₃, LiCF₃CO₂, LiAsF₆, LiB₁₀Cl₁₀, LiCl, LiBr, LiI, LiBCl₄, LiN(FSO₂)₂, and LiN(CF₃SO₂)₂. A single one or two or more in combination of these lithium salts may be used. Among these lithium salts, desirably used are at least one selected from the group consisting of a lithium salt having a halogen atom-containing oxo acid anion suitable as the anions, and a lithium salt having an imide anion.

The electrolytic solution further contains a quaternary ammonium salt. An anion of the quaternary ammonium salt may be the same as or different from the anion of the lithium salt. As a cation of the quaternary ammonium salt, those described above can be used.

The solvent may be a nonaqueous solvent. As the nonaqueous solvent, it is possible to use, for example, cyclic carbonates such as ethylene carbonate, propylene carbonate, and butylene carbonate; chain carbonates such as dimethyl carbonate, diethyl carbonate, and ethyl methyl carbonate; aliphatic carboxylate esters such as methyl formate, methyl acetate, methyl propionate, and ethyl propionate; lactones such as γ-butyrolactone (GBL) and γ-valerolactone; chain ethers such as 1,2-dimethoxyethane (DME), 1,2-diethoxyethane (DEE), and ethoxymethoxyethane (EME); cyclic ethers such as tetrahydrofuran and 2-methyltetrahydrofuran; dimethylsulfoxide, 1,3-dioxolane, formamide, acetamide, dimethylformamide, dioxolane, acetonitrile, propionitrile, nitromethane, ethylmonoglyme, trimethoxymethane, sulfolane, methyl sulfolane, and 1,3-propanesultone. A single one or two or more in combination of these nonaqueous solvents may be used.

The electrolytic solution may also contain the covering film formation agent described above as necessary. The covering film formation agent forms a covering film having high lithium-ion conductance on the surface of the negative electrode and suppresses, on the negative electrode, decomposition of a component (for example, the quaternary ammonium ion) in the electrolytic solution.

### (Manufacturing Method)

Hereinafter, one example of a method for manufacturing the electrochemical device according to the present invention is described with reference to FIGS. 2 and 3. Meanwhile, the method for manufacturing the electrochemical device according to the present invention is not limited to this example.

Electrochemical device 100 is manufactured by a method including the steps of, for example, applying a carbon paste to positive current collector 111 to form a coating film and then drying the coating film to form carbon layer 112; forming active layer 113 containing a conductive polymer on the carbon layer to give positive electrode 11; and stacking obtained positive electrode 11, separator 13, and negative electrode 12 in this order. Further, electrode group 10 obtained by stacking positive electrode 11, separator 13, and negative electrode 12 in this order is housed together with an electrolytic solution in container 101. Active layer 113 is usually formed in an acidic atmosphere due to an influence of an oxidant or a dopant used.

A method for applying the carbon paste to positive current collector 111 is not particularly limited, and examples of the method include common application methods such as a screen printing method, a coating method using various coaters, e.g., a blade coater, a knife coater, and a gravure coater, and a spin coating method. The drying of the obtained coating film may be performed, for example, at a temperature ranging from 130° C. to 170° C. for a time ranging from 5 minutes to 120 minutes. By these procedures, dense film-shaped carbon layer 112 can be easily formed.

Active layer 113 is, as described above, formed by, for example, electrolytically polymerizing or chemically polymerizing a raw material monomer in presence of positive current collector 111 equipped with carbon layer 112. Alternatively, the active layer is formed by applying, for example, a solution containing a conductive polymer or a dispersion of a conductive polymer to positive current collector 111 equipped with carbon layer 112.

A lead member (lead tab 105A equipped with lead wire 104A) is connected to positive electrode 11 obtained as described above, and the other lead member (lead tab 105B equipped with lead wire 104B) is connected to negative electrode 12. Subsequently, positive electrode 11 and negative electrode 12 to which these lead members are connected are wound, with separator 13 interposed between the positive electrode and the negative electrode, to give electrode group 10 that is illustrated in FIG. 3 and exposes the lead members from one end surface of the electrode group. An outermost periphery of electrode group 10 is fixed with fastening tape 14.

Next, as illustrated in FIG. 2, electrode group 10 is housed together with an electrolytic solution (not illustrated) in bottomed cylindrical container 101 having an opening. Lead wires 104A, 104B are led out from sealing body 102. Sealing body 102 is disposed in the opening of container 101 to seal container 101. Specifically, container 101 is, at a part near an opening end, drawn inward, and is, at the opening end, curled to swage sealing body 102. Sealing body 102 is formed of, for example, an elastic material containing a rubber component.

In the exemplary embodiment, a wound cylinder-shaped electrochemical device has been described. Meanwhile, an application range of the present invention is not limited to the exemplary embodiment described above, and the present invention is also applicable to a square or rectangle-shaped wound or stacked electrochemical device.

### Example

Hereinafter, the present invention is described in more detail based on examples. Meanwhile, the present invention is not to be limited to the examples.

### <<Electrochemical Devices A1 to A26 and B1>>

### (1) Production of Positive Electrode

A 30-μm-thick aluminum foil was prepared as a positive current collector. On the other hand, an aqueous aniline solution containing aniline and sulfuric acid was prepared.

A carbon paste obtained by kneading carbon black with water was applied to entire front and back surfaces of the positive current collector and then dried by heating to form a carbon layer. The carbon layer had a thickness of 2 μm per one surface.

The positive current collector on which the carbon layer had been formed and an opposite electrode were immersed in the aqueous aniline solution containing sulfuric acid, and electrolytic polymerization was performed at a current density of 10 mA/cm² for 20 minutes to attach a film of a conductive polymer (polyaniline) doped with sulfate ions (SO₄²⁻) onto the carbon layer on the front and back surfaces of the positive current collector.

The conductive polymer doped with the sulfate ions was reduced for dedoping of the doping sulfate ions. Thus, an active layer was formed, containing the conductive polymer that had been subjected to dedoping of the sulfate ions. Next, the active layer was sufficiently washed and thereafter dried. The active layer had a thickness of 35 μm per one surface.

### (2) Production of Negative Electrode

A 20-μm-thick copper foil was prepared as a negative current collector. On the other hand, a negative electrode mixture paste was prepared by kneading a mixed powder containing 97 parts by mass of hard carbon, 1 part by mass of carboxy cellulose, and 2 parts by mass of styrene-butadiene rubber with water at a weight ratio of 40:60. The negative electrode mixture paste was applied to both surfaces of the negative current collector and dried to give a negative electrode including a 35-μm-thick negative electrode material layer on both surfaces. Next, a metallic lithium foil was attached to the negative electrode material layer in an amount calculated so that the negative electrode that had been pre-doped and was in an electrolytic solution had a potential of less than or equal to 0.2 V with respect to a potential of metallic lithium.

### (3) Production of Electrode Group

Lead tabs were respectively connected to the positive electrode and the negative electrode, and then, as illustrated in FIG. 3, a stacked body obtained by alternately stacking a nonwoven fabric separator (thickness 35 μm) made of cellulose, the positive electrode, and the negative electrode was wound to form an electrode group.

### (4) Preparation of Electrolytic Solution

An electrolytic solution was prepared by mixing γ-butyrolactone (GBL) as a solvent, a lithium salt, a quaternary ammonium salt, and a covering film formation agent. In Table 1, compounds for the lithium salt and the quaternary ammonium salt are shown, and molar concentrations of the lithium salt and molar concentrations of the quaternary ammonium salt are shown as content proportions A of the lithium salt and content proportions B of the quaternary ammonium salt, respectively. Table 2 shows compounds for the covering film formation agent, which were added at content proportion (% by weight) shown in Table 2 in an entirety of the electrolytic solution.

### (5) Production of Electrochemical Devices

The electrode group and the electrolytic solution were housed in a bottomed container having an opening to assemble the electrochemical device illustrated in FIG. 2. Thereafter, aging was performed by applying a charge voltage of 3.8 V between terminals of the positive electrode and the negative electrode at 25° C. for 24 hours, to progress pre-doping of the negative electrode with lithium ions.

Thus, electrochemical devices A1 to A26 and B1 were produced that had different compositions of the electrolytic solution. The electrochemical device B1 is a comparative example, and the electrolytic solution contains no quaternary ammonium salt. The electrochemical devices A9 to A19 were produced by changing the compound and the content proportion thereof for the covering film formation agent from those of the electrochemical device A4. In the electrochemical device A17, to the electrolytic solution were added both maleic anhydride (MAH) and succinic anhydride (SAH) as the covering film formation agent each at a concentration of 1.5% by weight. The electrochemical devices A20 to A24 were produced by changing the compound as the quaternary ammonium salt from that of the electrochemical device A17. The electrochemical devices A25 and A26 were produced by changing the content proportions of the lithium salt and the quaternary ammonium salt from those of the electrochemical device A4, while the ratio A/B was fixed.

### <<Electrochemical Devices A27 to A46 and B2>>

In the preparation of the electrolytic solution, a solvent was used that was obtained by mixing PC, EC, DMC, and MP at a mass ratio of 20:30:30:20. An electrolytic solution was prepared by mixing a lithium salt, a quaternary ammonium salt, and a covering film formation agent in the mixed solvent. In Table 3, compounds for the lithium salt and the quaternary ammonium salt are shown, and molar concentrations of the lithium salt and molar concentrations of the quaternary ammonium salt are shown as content proportions A of the lithium salt and content proportions B of the quaternary ammonium salt, respectively. Table 4 shows compounds for the covering film formation agent, which were added at content proportion (% by weight) shown in Table 4 in an entirety of the electrolytic solution.

Except for the above, electrochemical devices A27 to A46 and B2 were produced similarly to the electrochemical devices A1 to A26. The electrochemical device B2 is a comparative example, and the electrolytic solution contains no quaternary ammonium salt. The electrochemical devices A29 to A39 were produced by changing the compound and the content proportion thereof for the covering film formation agent from those of the electrochemical device A27. In the electrochemical device A37, to the electrolytic solution were added both maleic anhydride (MAH) and succinic anhydride (SAH) as the covering film formation agent each at a concentration of 1.5% by weight. The electrochemical devices A40 to A44 were produced by changing the compound as the quaternary ammonium salt from that of the electrochemical device A37. The electrochemical devices A45 and A46 were produced by changing the content proportions of the lithium salt and the quaternary ammonium salt from those of the electrochemical device A27, while the ratio A/B was fixed.

### <<Electrochemical Devices A47 to A49>>

In the preparation of the electrolytic solution, a solvent was used that was obtained by mixing PC, EC, and DMC at a mass ratio of 25:25:50. Except for the above, an electrochemical device A47 was produced similarly to the electrochemical device A37.

Similarly using, in the preparation of the electrolytic solution, a mixed solvent obtained by mixing PC, EC, DMC, and MP at a mass ratio of 30:20:40:10, an electrochemical device A48 was produced similarly to the electrochemical device A37 except for the mixed solvent.

Similarly using, in the preparation of the electrolytic solution, a mixed solvent obtained by mixing PC, EC, DMC, and MP at a mass ratio of 20:30:20:30, an electrochemical device A49 was produced similarly to the electrochemical device A37 except for the mixed solvent.

### (Evaluations)

### (1) Internal Resistance (DCR)

An initial internal resistance (initial DCR) was obtained from an amount of voltage drop when the electrochemical device was charged at a voltage of 3.6 V and then discharged for a prescribed time (0.05 seconds to 0.2 seconds). Tables 1 and 3 show results of the evaluation. Table 1 shows relative values, with the initial internal resistance of the electrochemical device B1 defined as 100. Table 3 shows relative values, with the initial internal resistance of the electrochemical device B2 defined as 100.

### (2) Initial Capacitance

The electrochemical device was charged at a voltage of 3.8 V and then discharged at a current of 5.0 A up to 2.5 V in a 25° C. environment. A discharge amount flowed halfway through the discharging, that is, while the voltage was decreased from 3.3 V to 3.0 V was divided by a voltage change ΔV (=0.3 V), and the obtained value was defined as an initial capacitance C₀ (F). Tables 1 and 3 show results of the evaluation. Table 1 shows relative values, with the initial capacitance of the electrochemical device B1 defined as 100. Table 3 shows relative values, with the initial capacitance of the electrochemical device B2 defined as 100.

### (3) Float Property

The electrochemical device was continuously charged for 1000 hours under conditions of 60° C. and 3.6 V. Thereafter, the electrochemical device was discharged at a current of 5.0 A up to 2.5 V, and a discharge amount flowed halfway through the discharging, that is, while the voltage was decreased from 3.3 V to 3.0 V was divided by a voltage change ΔV (=0.3 V) to give a capacitance C₁ (F). A change rate of the capacitance after the continuous charging to a (initial) capacitance C₀ before the continuous charging was calculated by a formula C₁/C₀×100. Tables 1 and 3 show results of the evaluation. Table 1 shows relative values, with the capacitance change rate of the electrochemical device B1 defined as 100. Table 3 shows relative values, with the capacitance change rate of the electrochemical device B2 defined as 100.

Tables 1 and 3 clarify a fact that the electrochemical devices A1 to A49 that included the electrolytic solution containing the quaternary ammonium salt improved the initial DCR and the initial capacitance compared to the electrochemical device B1 or B2 containing no quaternary ammonium salt. In addition, the addition of the covering film formation agent to the electrolytic solution suppressed the decrease of the float property. Under the conditions of the same covering film formation agent and the same content proportion thereof, the electrochemical devices that included the electrolytic solution containing ethylene carbonate (EC) are likely to have a larger effect of improving both the initial properties and the float property than that of the electrochemical devices containing γ-butyrolactone (GBL).

TABLE 1

| | Lithium salt | | Quaternary ammonium salt | | | | | |
|---|---|---|---|---|---|---|---|---|
| | | Content | | Content | | | | |
| | | proportion | | proportion | | | | |
| | | A | | B | | Initial | Initial | Float |
| | Compound | (mol/L) | Compound | (mol/L) | A/B | DCR | capacitance | property |
| B1 | LiPF₆ | 2 | — | — | | 100 | 100 | 100 |
| A1 | LiPF₆ | 1.9 | DEDMA BF₄ | 0.1 | 19.0 | 99.1 | 100.5 | — |
| A2 | LiPF₆ | 1.8 | DEDMA BF₄ | 0.2 | 9.0 | 94.5 | 105.6 | — |
| A3 | LiPF₆ | 1.7 | DEDMA BF₄ | 0.3 | 5.7 | 81.3 | 118.3 | — |
| A4 | LiPF₆ | 1.5 | DEDMA BF₄ | 0.5 | 3.0 | 85.1 | 125.9 | 105.3 |
| A5 | LiPF₆ | 1.0 | DEDMA BF₄ | 1.0 | 1.0 | 87.3 | 117.1 | — |
| A6 | LiPF₆ | 0.5 | DEDMA BF₄ | 1.5 | 0.33 | 88.6 | 112.7 | — |
| A7 | LiPF₆ | 0.3 | DEDMA BF₄ | 1.7 | 0.2 | 91.0 | 106.3 | — |
| A8 | LiPF₆ | 0.2 | DEDMA BF₄ | 1.8 | 0.1 | 94.2 | 108.7 | — |
| A9 | LiPF₆ | 1.5 | DEDMA BF₄ | 0.5 | 3.0 | 78.2 | 137.0 | 130.2 |
| A10 | LiPF₆ | 1.5 | DEDMA BF₄ | 0.5 | 3.0 | 81.6 | 131.3 | 126.5 |
| A11 | LiPF₆ | 1.5 | DEDMA BF₄ | 0.5 | 3.0 | 84.1 | 127.1 | 123.9 |
| A12 | LiPF₆ | 1.5 | DEDMA BF₄ | 0.5 | 3.0 | 85.3 | 125.2 | 122.6 |
| A13 | LiPF₆ | 1.5 | DEDMA BF₄ | 0.5 | 3.0 | 81.8 | 130.7 | 126.3 |
| A14 | LiPF₆ | 1.5 | DEDMA BF₄ | 0.5 | 3.0 | 80.9 | 132.1 | 127.3 |
| A15 | LiPF₆ | 1.5 | DEDMA BF₄ | 0.5 | 3.0 | 82.5 | 129.5 | 125.6 |
| A16 | LiPF₆ | 1.5 | DEDMA BF₄ | 0.5 | 3.0 | 83.6 | 127.8 | 121.3 |
| A17 | LiPF₆ | 1.5 | DEDMA BF₄ | 0.5 | 3.0 | 76.6 | 130.2 | 134.5 |
| A18 | LiPF₆ | 1.5 | DEDMA BF₄ | 0.5 | 3.0 | 80.6 | 128.6 | 124.3 |
| A19 | LiPF₆ | 1.5 | DEDMA BF₄ | 0.5 | 3.0 | 81.9 | 126.8 | 121.5 |
| A20 | LiPF₆ | 1.5 | DEDMA PF₆ | 0.5 | 3.0 | 86.7 | 128.3 | 131.3 |
| A21 | LiPF₆ | 1.5 | TEA BF₄ | 0.5 | 3.0 | 87.2 | 129.0 | 121.3 |
| A22 | LiPF₆ | 1.5 | TEMA BF₄ | 0.5 | 3.0 | 86.3 | 127.7 | 121.5 |
| A23 | LiPF₆ | 1.5 | SBP BF₄ | 0.5 | 3.0 | 84.9 | 125.6 | 123.0 |
| A24 | LiPF₆ | 1.5 | SBP PF₆ | 0.5 | 3.0 | 85.3 | 126.2 | 122.6 |
| A25 | LiPF₆ | 0.375 | DEDMA BF₄ | 0.125 | 3.0 | 98.2 | 101.4 | — |
| A26 | LiPF₆ | 2.25 | DEDMA BF₄ | 0.75 | 3.0 | 96.3 | 102.3 | — |

TABLE 2

| | Covering film formation agent | | | | | |
|---|---|---|---|---|---|---|
| | Cyclic carboxylic acid | | Unsaturated cyclic | | Bidentate ligand-containing | |
| | anhydride | | carbonate ester | | complex anion | |
| | | Content | | Content | | Content |
| | | proportion | | proportion | | proportion |
| | Compound | (wt %) | Compound | (wt %) | Compound | (wt %) |
| B1 | | | VC | 5 | | |
| A1 | | | VC | 5 | | |
| A2 | | | VC | 5 | | |
| A3 | | | VC | 5 | | |
| A4 | | | VC | 5 | | |
| A5 | | | VC | 5 | | |
| A6 | | | VC | 5 | | |
| A7 | | | VC | 5 | | |
| A8 | | | VC | 5 | | |
| A9 | SAH | 3 | | | | |
| A10 | MAH | 3 | | | | |
| A11 | | | | | Chemical formula (3) | 0.5 |
| A12 | | | | | Chemical formula (2) | 0.5 |
| A13 | | | | | Chemical formula (4) | 0.5 |
| A14 | SAH | 1.5 | VC | 2.5 | | |
| A15 | MAH | 1.5 | VC | 2.5 | | |
| A16 | | | VC | 2.5 | Chemical formula (4) | 0.5 |
| A17 | SAH | 1.5 | | | | |
| | MAH | 1.5 | | | | |
| A18 | SAH | 1.5 | | | Chemical formula (4) | 0.5 |
| A19 | MAH | 1.5 | | | Chemical formula (4) | 0.5 |
| A20 | SAH | 1.5 | | | | |
| | MAH | 1.5 | | | | |
| A21 | SAH | 1.5 | | | | |
| | MAH | 1.5 | | | | |
| A22 | SAH | 1.5 | | | | |
| | MAH | 1.5 | | | | |
| A23 | SAH | 1.5 | | | | |
| | MAH | 1.5 | | | | |
| A24 | SAH | 1.5 | | | | |
| | MAH | 1.5 | | | | |
| A25 | | | VC | 5 | | |
| A26 | | | VC | 5 | | |

TABLE 3

| | Lithium salt | | Quaternary ammonium salt | | | | | |
|---|---|---|---|---|---|---|---|---|
| | | Content | | Content | | | | |
| | | proportion | | proportion | | | | |
| | | A | | B | | Initial | Initial | Float |
| | Compound | (mol/L) | Compound | (mol/L) | A/B | DCR | capacitance | property |
| B2 | LiPF₆ | 2 | — | — | | 100 | 100 | 100 |
| A27 | LiPF₆ | 1.5 | DEDMA BF₄ | 0.5 | 3.0 | 84.2 | 125.8 | 110.1 |
| A28 | LiPF₆ | 0.2 | DEDMA BF₄ | 1.8 | 0.1 | 93.2 | 110.1 | — |
| A29 | LiPF₆ | 1.5 | DEDMA BF₄ | 0.5 | 3.0 | 77.2 | 138.0 | 135.8 |
| A30 | LiPF₆ | 1.5 | DEDMA BF₄ | 0.5 | 3.0 | 80.8 | 131.5 | 132.1 |
| A31 | LiPF₆ | 1.5 | DEDMA BF₄ | 0.5 | 3.0 | 82.5 | 127.1 | 129.7 |
| A32 | LiPF₆ | 1.5 | DEDMA BF₄ | 0.5 | 3.0 | 84.6 | 126.1 | 128.0 |
| A33 | LiPF₆ | 1.5 | DEDMA BF₄ | 0.5 | 3.0 | 81.5 | 130.9 | 131.8 |
| A34 | LiPF₆ | 1.5 | DEDMA BF₄ | 0.5 | 3.0 | 80.7 | 131.5 | 132.6 |
| A35 | LiPF₆ | 1.5 | DEDMA BF₄ | 0.5 | 3.0 | 82.6 | 129.6 | 131.5 |
| A36 | LiPF₆ | 1.5 | DEDMA BF₄ | 0.5 | 3.0 | 83.4 | 128.7 | 126.4 |
| A37 | LiPF₆ | 1.5 | DEDMA BF₄ | 0.5 | 3.0 | 75.8 | 131.2 | 140.3 |
| A38 | LiPF₆ | 1.5 | DEDMA BF₄ | 0.5 | 3.0 | 79.6 | 129.0 | 129.6 |
| A39 | LiPF₆ | 1.5 | DEDMA BF₄ | 0.5 | 3.0 | 82.3 | 126.8 | 127.1 |
| A40 | LiPF₆ | 1.5 | DEDMA PF₆ | 0.5 | 3.0 | 86.9 | 129.7 | 135.1 |
| A41 | LiPF₆ | 1.5 | TEA BF₄ | 0.5 | 3.0 | 87.5 | 130.8 | 125.8 |
| A42 | LiPF₆ | 1.5 | TEMA BF₄ | 0.5 | 3.0 | 85.4 | 127.5 | 126.1 |
| A43 | LiPF₆ | 1.5 | SBP BF₄ | 0.5 | 3.0 | 84.1 | 125.8 | 127.4 |
| A44 | LiPF₆ | 1.5 | SBP PF₆ | 0.5 | 3.0 | 84.5 | 126.5 | 129.1 |
| A45 | LiPF₆ | 0.375 | DEDMA BF₄ | 0.125 | 3.0 | 97.7 | 101.9 | — |
| A46 | LiPF₆ | 2.25 | DEDMA BF₄ | 0.75 | 3.0 | 95.8 | 102.8 | — |
| A47 | LiPF₆ | 1.5 | DEDMA BF₄ | 0.5 | 3.0 | 85.5 | 126.0 | 129.1 |
| A48 | LiPF₆ | 1.5 | DEDMA BF₄ | 0.5 | 3.0 | 85.0 | 127.1 | 129.6 |
| A49 | LiPF₆ | 1.5 | DEDMA BF₄ | 0.5 | 3.0 | 84.6 | 128.0 | 130.2 |

TABLE 4

| | Covering film formation agent | | | | | |
|---|---|---|---|---|---|---|
| | Cyclic carboxylic acid | | Unsaturated cyclic | | Bidentate ligand-containing | |
| | anhydride | | carbonate ester | | complex anion | |
| | | Content | | Content | | Content |
| | | proportion | | proportion | | proportion |
| | Compound | (wt %) | Compound | (wt %) | Compound | (wt %) |
| B2 | | | VC | 5 | | |
| A27 | | | VC | 5 | | |
| A28 | | | VC | 5 | | |
| A29 | SAH | 3 | | | | |
| A30 | MAH | 3 | | | | |
| A31 | | | | | Chemical formula (3) | 0.5 |
| A32 | | | | | Chemical formula (2) | 0.5 |
| A33 | | | | | Chemical formula (4) | 0.5 |
| A34 | SAH | 1.5 | VC | 2.5 | | |
| A35 | MAH | 1.5 | VC | 2.5 | | |
| A36 | | | VC | 2.5 | Chemical formula (4) | 0.5 |
| A37 | SAH | 1.5 | | | | |
| | MAH | 1.5 | | | | |
| A38 | SAH | 1.5 | | | Chemical formula (4) | 0.5 |
| A39 | MAH | 1.5 | | | Chemical formula (4) | 0.5 |
| A40 | SAH | 1.5 | | | | |
| | MAH | 1.5 | | | | |
| A41 | SAH | 1.5 | | | | |
| | MAH | 1.5 | | | | |
| A42 | SAH | 1.5 | | | | |
| | MAH | 1.5 | | | | |
| A43 | SAH | 1.5 | | | | |
| | MAH | 1.5 | | | | |
| A44 | SAH | 1.5 | | | | |
| | MAH | 1.5 | | | | |
| A45 | | | VC | 5 | | |
| A46 | | | VC | 5 | | |
| A47 | SAH | 1.5 | | | | |
| | MAH | 1.5 | | | | |
| A48 | SAH | 1.5 | | | | |
| | MAH | 1.5 | | | | |
| A49 | SAH | 1.5 | | | | |
| | MAH | 1.5 | | | | |

### INDUSTRIAL APPLICABILITY

An electrochemical device according to the present invention has an excellent float property and is therefore suitable as various electrochemical devices, particularly as a back-up power source.

### REFERENCE MARKS IN THE DRAWINGS

10 electrode group
11 positive electrode
111 positive current collector
112 carbon layer
113 active layer
12 negative electrode
13 separator
14 fastening tape
100 electrochemical device
101 container
102 sealing body
103 base plate
104A, 104B lead wire
105A, 105B lead tab

1. An electrochemical device comprising:
a positive electrode including a positive electrode active material;
a negative electrode including a negative electrode active material; and
an electrolytic solution, wherein:
the positive electrode active material includes a conductive polymer,
the electrolytic solution contains anions and cations,
the conductive polymer is capable of doping and dedoping of the anions,
the cations includes a lithium ion and a quaternary ammonium ion.

2. The electrochemical device according to claim 1, wherein a ratio AB satisfies 0.2≤A/B, where A represents a molar concentration of the lithium ion in the electrolytic solution, and B represents a molar concentration of the quaternary ammonium ion in the electrolytic solution.

3. The electrochemical device according to claim 1, wherein a concentration of the anions in the electrolytic solution ranges from 0.5 mol/L to 3 mol/L, inclusive.

4. The electrochemical device according to claim 3, wherein the anions include at least one selected from the group consisting of a hexafluorophosphate ion and a tetrafluoroborate ion.

5. The electrochemical device according to claim 1, wherein the electrolytic solution contains at least one selected from the group consisting of an unsaturated cyclic carbonate ester, a cyclic carboxylic acid anhydride, and a bidentate ligand-containing complex.

6. The electrochemical device according to claim 5, wherein the unsaturated cyclic carbonate ester includes vinylene carbonate.

7. The electrochemical device according to claim 5, wherein the cyclic carboxylic acid anhydride includes at least one selected from the group consisting of maleic anhydride and succinic anhydride.

8. The electrochemical device according to claim 5, wherein the bidentate ligand-containing complex includes at least one selected from the group consisting of anions represented by a following chemical formula (1): 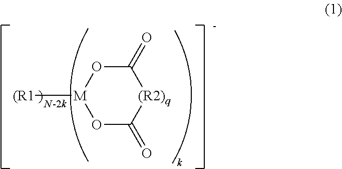
where, M represents boron or phosphorus; N is 4 when M represents boron, or N is 6 when M represents phosphorus; k is an integer satisfying k≥1 and N−2k≥0; q is 0 or 1; R1 represents a halogen group; and R2 represents an alkylene group having 1 to 5 carbon atoms when q is 1, or two carbonyl groups are directly bonded to each other when q is 0.

9. The electrochemical device according to claim 8, wherein the bidentate ligand-containing complex includes at least one selected from anions represented by following chemical formulae (2) to (6):

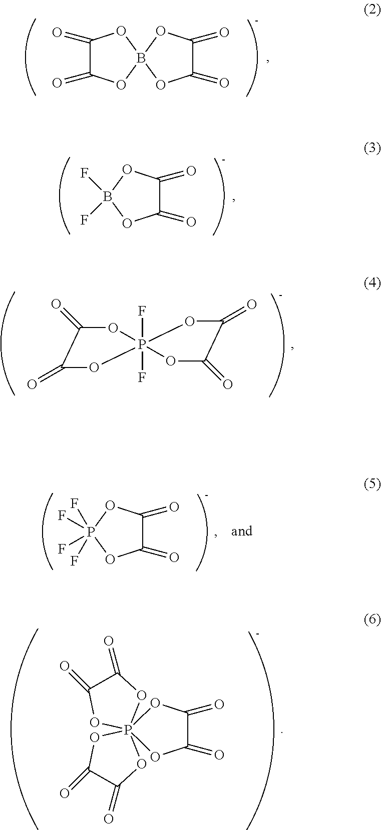

10. The electrochemical device according to claim 1, wherein the quaternary ammonium ion includes at least one selected from the group consisting of a tetraethyl ammonium ion, a triethylmethyl ammonium ion, a diethyldimethyl ammonium ion, a trimethylpropyl ammonium ion, a trimethylethyl ammonium ion, a spirobipyrrolidinium ion, and a 1-ethyl-1-methylpyrrolidinium ion.
